(19) United States
(12) Patent Application Publication
(10) Pub. No.: US 2024/0102503 A1
(43) Pub. Date: Mar. 28, 2024

(54) FASTENING DEVICE FOR FASTENING A MECHANICAL ELEMENT WITH A SUPPORT STRUCTURE AS WELL AS FASTENING SYSTEM

(71) Applicant: Airbus Operations GmbH, Hamburg (DE)

(72) Inventors: Hermann BENTHIEN, Hamburg (DE); Andreas POPPE, Hamburg (DE); Stefan BENTHIEN, Hamburg (DE)

(21) Appl. No.: 18/468,373

(22) Filed: Sep. 15, 2023

(30) Foreign Application Priority Data
Sep. 23, 2022 (EP) 22197294.6

(51) Int. Cl. F16B 21/06

(52) U.S. Cl. CPC F16B 21/065

(57) ABSTRACT

A fastening device (1) for fastening mechanical element (2) with support structure (3) to fasten a cabin fitting element to a frame of an aircraft, fastening device (1) includes: enclosure (4) mountable to support structure (3); locator bush (5) in enclosure (4 and slidable along longitudinal axis (X) in an unlocked position of the fastening device (1); retaining element (6) around the longitudinal axis (X) and mechanically coupled to locator bush (5); and locking bolt (7) with a bolt head (8) mounting mechanical element (2) between bolt head (8) and enclosure (4), wherein locking bolt (7) is slidable into locator bush (5), and locking bolt (7) has a recess (9) on at least a section of a shell surface of locking bolt (7) and is positively-locking connectable with retaining element (6).

### RELATED APPLICATION

This application incorporates by reference and claims priority to European Patent Application EP 22197294.6; filed Sep. 23, 2022.

### TECHNICAL FIELD

The invention relates to a fastening device for fastening a mechanical element with a support structure. The invention is furthermore concerned with fastening system containing such a fastening device.

### BACKGROUND

Modern vehicles such as aircraft and spacecraft are manufactured in sections, that are pre-assembled. For attaching further components to those sections attachment systems are needed. Especially in the field of aircraft and spacecraft a high precision in manufacturing is important.

Further, the interior lining of aircraft is generally composed of individual elements, in which substantially plates or panels are placed adjacent to each other in a given framework or support structure. These plates or panels serve for example as cabin fitting elements.

Nevertheless, each section and component or plate/panel of the aircraft has different manufacturing tolerances, which are to match during assembly processes.

For example, US published patent application 2015/0125235 A1 describes an attachment device for attaching at least one element to a section of a component. Furthermore, in document U.S. Pat. No. 11,060,545 B2 a fastening system for securing a component is described.

### SUMMARY OF INVENTION

Aspects of the invention may provide solutions for an alternative fastening device for fastening mechanical elements to support structures.

According to a first aspect of the invention, a fastening device for fastening a mechanical element with a support structure is provided. In particular, a fastening device for fastening a cabin fitting element to a frame of an aircraft is provided. The fastening device comprises an enclosure, which is mountable to the support structure, and a locator bush, which is housed in the enclosure, wherein the locator bush is slidable along a longitudinal axis of the fastening device in relation to the enclosure in an unlocked position of the fastening device. Furthermore, the fastening device comprises a retaining element, which is positioned at least sectionwise around the longitudinal axis in the enclosure and mechanically coupled to the locator bush. The fastening device further comprises a locking bolt, which has a bolt head for mounting the mechanical element between the bolt head and the enclosure, wherein the locking bolt is configured to be slidable into the locator bush. Further the locking bolt has a recess, which is located on at least a section of the shell surface of the locking bolt and configured to be positively-locking connectable with the retaining element.

According to a second aspect of the invention, a fastening system is provided. The fastening system comprises a support structure and a fastening device according to the invention, wherein the enclosure is mounted to the support structure. Furthermore, the fastening system comprises a mechanical element, which is positively-locking connected with the fastening device.

The invention may be embodied to attach a blind fastening device for high load introduction on a limited space of the support structure. The fastening system is installed by pushing the locking bolt into the enclosure, wherein the enclosure is mounted at a predetermined position on the support structure. The locking bolt passes through an opening of the mechanical element for having a positively-locking connection, wherein the bolt head has greater outer dimensions than the opening of the mechanical element such that the positively-locking connection works between the bolt head and the enclosure. In a locked position of the fastening device, the retaining element limits the movability of the locking bolt in the longitudinal axis of the fastening device in relation to the enclosure. Thereby, the fastening device works as a snap and click mechanism.

A particular advantage in the solution according to an aspect of the invention is that manufacturing efforts for assembling cabin fitting elements with the frame of the aircraft is reduced. Furthermore, the fastening device can be used for attaching a primary structure interface to the support structure with combining an inplane tolerance compensation of the manufacturing tolerances of the support structure. Therefore, further attachments, which are tolerance sensitive, can be attached to the primary structure interface. A guided installation of the mechanical element can lead to an automated tolerance compensation when mounted with the fastening device.

Embodiments and further developments of the invention are evident from the following description with reference to the figures.

According to some aspects of the fastening device according to the invention, the retaining element is fixed in relation to the enclosure along the longitudinal axis and movable perpendicular to the longitudinal axis. That means the retaining element has a fixed orientation while it can be moved laterally in relation to the longitudinal axis. Thus, the retaining element can be used as a fixation element until a final fixation of the locking bolt, for example. Furthermore, a direct load transfer of the mechanical element into the support structure, in particular in the longitudinal axis, can be improved.

According to some further aspects of the fastening device according to the invention, the locator bush is configured to bring the retaining element into engagement with the recess of the locking bolt in a locked position of the fastening device. As a result, once the locked position is reached the locking bolt is mechanically connected to the enclosure/support structure. Thereby, only in the locked position of the fastening device the locking bolt is connected properly. In the unlocked position the locking bolt can be inserted without mechanical resistance. Therefore, for example, pulling back the locking bolt can test, if the fastening device is in the locked position.

According to some further aspects of the fastening device according to the invention, the recess of the locking bolt is circumferential around the shell surface of the locking bolt. The circumferential recess would not only apply to a cylindrical locking bolt, but also to a cuboid or a mixed form of locking bolts. Thereby, the circumferential recess extends in a peripheral direction around the shell surface of the locking bolt, irrespective of the shape of the locking bolt. Alternatively or additionally, the recess of the locking bolt has a rectangular, a triangular, a curved or a combination thereof cross-sectional shape. The retaining element has a mutually adapted shape.

According to some further aspects the fastening device further comprises a positioning element, which is fixed to the enclosure and configured to block a movement of the retaining element along the longitudinal axis in relation to the enclosure. Thus, preparing the enclosure or the fastening device for mounting to the support structure can be simplified.

According to some further aspects of the fastening device according to the invention, the locking bolt further comprises a thread in its front area, wherein at least a section of the threaded front area reaches through the locator bush and the enclosure in the locked position of the fastening device. In particular, the thread in the front area of the locking bolt is configured as an outer thread. Therefore, coupling of other attachments is enabled on the opposite side of the bolt head in relation to the enclosure when mounting these other attachments by means of the threaded front area.

According to some further aspects the fastening device further comprises a nut, which is mounted on the threaded front area of the locking bolt such that the bolt head, the mechanical element, the support structure and the enclosure are pressed together in the locked position of the fastening device. Thus, the fastening device can be pre-tensioned. Furthermore, the nut can bear more load than the retaining element, in particular in the longitudinal axis when supported by the enclosure. As a result, the retaining element can be sized smaller or can be made of a lighter material since it is not under load when the nut is mounted.

According to some further aspects of the fastening device according to the invention, the retaining element is configured as a retaining ring, which is kept under pre-tension for installing the retaining ring on the locking bolt in the unlocked position of the fastening device by the locator bush and which is engaged with the recess of the locking bolt in a locked position of the fastening device. Thus, in the unlocked position the locking bolt can be inserted and slid through the retaining ring without mechanical resistance. Therefore, the fastening device can be easy to install, in particular the locking bolt can be inserted and the fastening device can be locked one-handed. The retaining ring can be configured as an outer retaining ring or an inner retaining ring.

According to some further aspects of the fastening device according to the invention, the retaining element is configured as a sliding block, which slides guidedly towards the recess of the locking bolt, when the locking bolt pushes the locator bush in the longitudinal axis in relation to the enclosure. Thus, the fastening device can have a self-locking function, in particular prior to the locked position of the fastening device, since the retaining element may continuously slide into the recess, wherein the self-locking function is present in an intermediate position, in which the retaining element at least partly protrudes into the recess of the locking bolt.

According to some further aspects of the fastening device according to the invention, the retaining element comprises a pre-tensioned spring for bringing the retaining element into engagement with the recess of the locking bolt, when the locator bush is slid in the locked position of the fastening device and thereby releases the spring.

According to some further aspects of the fastening device according to the invention, the locator bush is configured as a pivoting clamp, which holds the retaining element and reaches into an insertion area of the enclosure for inserting the locking bolt such that the locking bolt triggers the clamp to bring the retaining element into engagement with the recess of the locking bolt, when the locking bolt is inserted into the enclosure in the locked position of the fastening device.

According to some aspects of the fastening system according to the invention, the support structure is configured as a frame of an aircraft, and wherein the mechanical element is configured as a cabin fitting element in a cabin of the fuselage of an aircraft. Thus, aircraft components are well-tested and mostly standardized.

According to some further aspects of the fastening system according to the invention, the fastening device is installed in an opening of the frame. Thus, a direct load transfer of the mechanical element into the support structure can be enabled. Furthermore, this installation can reduce the space needed for the fastening system.

According to some further aspects the fastening system further comprises an anti-slip inlay between the mechanical element and the support structure for reducing a movement of the mechanical element perpendicular to a longitudinal axis of the fastening device in a locked position of the fastening device. As a result, using the anti-slip inlay can reduce a movement of the mechanical element after installation of the fastening system.

### SUMMARY OF DRAWINGS

The present invention is explained more specifically below on the basis of the exemplary embodiments indicated in the schematic figures, in which:

FIGS. 1A and 1B show a schematic illustration of a fastening device for fastening a mechanical element with a support structure according to an embodiment of the invention, wherein FIG. 1A shows the fastening device in an unlocked position and FIG. 1B shows the fastening device in a locked position;

FIGS. 2A and 2B show a schematic illustration of a fastening system according to an embodiment of the invention, wherein FIG. 2A shows the fastening system in an unlocked position of the fastening device and FIG. 2B shows the fastening system in a locked position of the fastening device;

FIG. 3 shows a schematic illustration of a fastening system according to FIG. 2A, 2B with a threaded front area of the locking bolt and a nut mounted on the threaded front area;

FIGS. 4A and 4B show a schematic illustration of an enclosure housing a locator bush according to an embodiment of the invention, wherein FIG. 4A shows the enclosure in a front view and FIG. 4B shows the enclosure in a sectional side view;

FIGS. 5A to 5C show a schematic illustration of a fastening device with a retaining element according to a further embodiment of the invention, wherein FIG. 5A shows the fastening device in an unlocked position, FIG. 5B shows the fastening device in an intermediate position and FIG. 5C shows the fastening device in a locked position;

FIGS. 6A and 6B show a schematic illustration of a fastening device with a retaining element according to a further embodiment of the invention, wherein FIG. 6A shows the fastening device in an unlocked position and FIG. 6B shows the fastening device in a locked position;

FIGS. 7A and 7B show a schematic illustration of a fastening device with a locator bush according to a further embodiment of the invention, wherein FIG. 7A shows the fastening device in an unlocked position and FIG. 7B shows the fastening device in a locked position.

### DETAILED DESCRIPTION

A retaining ring in the meaning of this application is a fastener that holds components or assemblies onto a shaft or in a housing/bore when installed, typically installed in a groove, for one time use only. Once installed, an exposed portion of the retaining ring acts as a shoulder, which retains the specific component or assembly. For example, a circlip or a snap ring is a type of retaining ring. Retaining rings are typically made from carbon steel, stainless steel or beryllium copper and may feature a variety of finishes for aesthetics and corrosion protection depending on the type of environment in which they are used.

A spring in the meaning of this application is an elastic object that stores mechanical energy. A spring is typically made of spring steel or similar materials. In particular, the spring is designed as a coil spring.

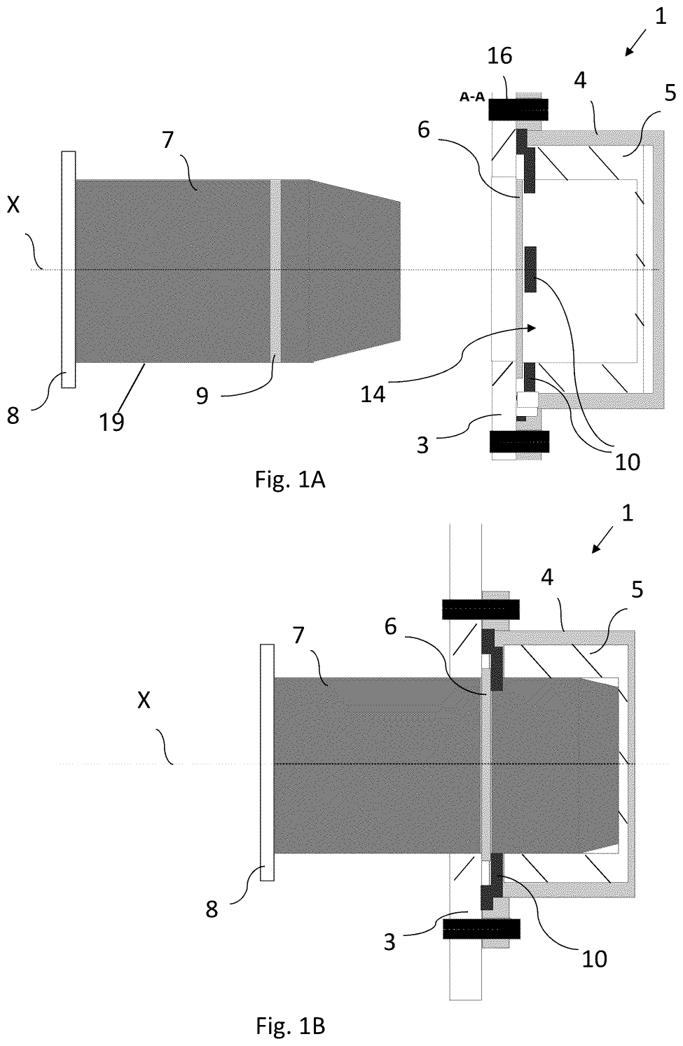

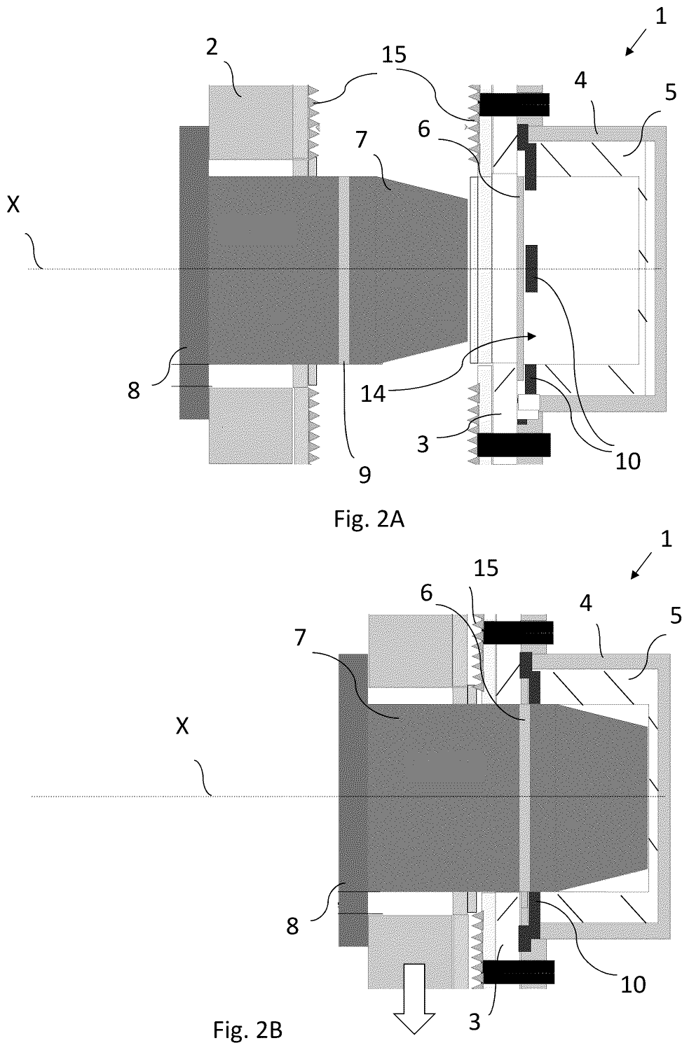

FIGS. 1A and 1B show a schematic illustration of a fastening device 1 for fastening a mechanical element 2 (FIGS. 2A and 2B) with a support structure 3. The mechanical element 2 may be a cabin fitting element for a cabin in a fuselage of an aircraft and the support structure 3 may be a frame in the fuselage. Thereby, FIG. 1A shows the fastening device 1 in an unlocked position and FIG. 1B shows the fastening device 1 in a locked position.

The fastening device 1 comprises an enclosure 4, a locator bush 5, a retaining element 6, a locking bolt 7 with a recess 9 in the shank 19, and a positioning element 10.

The enclosure 4 is exemplarily configured as a hollow cylinder with an opening on a face side of the enclosure 4. Furthermore, the enclosure comprises at least one through-hole for mounting the enclosure to a support structure 3 by a rivet 16 for example.

The locator bush 5 is housed in the enclosure. The locator bush 5 may be configured as a hollow cylinder, wherein the outer diameter of the locator bush 5 corresponds to the inner diameter of the enclosure 4. Although the locator bush 5 according to embodiment FIG. 1A, 1B is configured as a hollow cylinder, the locator bush 5 may also have a cylindrical shape on its outer shell and a cuboid shape on its inner shell of the locator bush 5. In the unlocked position, the locator bush 5 is slidable in the enclosure 4 in a longitudinal direction X of the fastening device 1.

The locking bolt 7 has a bolt head 8 and shank 19. The shell surface of the shank 19 of the locking bolt 7 fits into and has a cross-sectional shape similar to the cross-sectional shape of the inner shell of the locator bush 5. In particular the locking bolt 7 is configured cylindrical to fit in the hollow cylindrical locator bush 5. Furthermore, the locking bolt comprises a tapered front area.

The positioning element 10 is located at the face side of the enclosure 4. When the enclosure 4 is mounted to the support structure 3, as is illustrated in FIGS. 1A and 1B, the retaining element 6 placed between the support structure 3 and the positioning element 10.

In particular, FIG. 1B shows the fastening device 1 in the locked position, in which the locking bolt 7 reaches through a hole of the support structure 3 and in an insertion area 14 (FIG. 2A) of the locator bush 5. In the locked position, the retaining element 6 has a positively-locking connection with the recess of the locking bolt 7. Furthermore, the locator bush 5 is in an end position, in which the retaining element 6 is free to secure the locking bolt 7.

FIGS. 2A and 2B show a schematic illustration of a fastening system, wherein FIG. 2A shows the fastening system in an unlocked position of the fastening device 1 and FIG. 2B shows the fastening system in a locked position of the fastening device 1.

The fastening system comprises the fastening device 1 according to the embodiment of FIGS. 1A and 1B and further a mechanical element 2 as well as a support structure 3. The mechanical element 2 is configured as a pole with a hole at an end of the pole. The support structure 3 is a frame of an a fuselage in an aircraft, wherein the frame comprises a through-hole.

The fastening device 1 mounts the pole to the frame by a positively-locking connection, as it is illustrated in FIG. 2B. When in the locked position, the fastening device 1 can bear loads, which are charged on the fastening system in the longitudinal direction X and/or perpendicular to the longitudinal direction X (see arrow in FIG. 2B). To compensate inaccuracies the hole of the pole through which the locking bolt passes, has a greater diameter than the shell surface of the locking bolt 7, such that there is a gap between the shell surface and the pole. Therefore, the pole 2 can move in relation to the fastening device 1 perpendicular to the longitudinal axis X.

Optionally, an anti-slip inlay 15 is placed between the pole 2 and the frame 3 of the aircraft for reducing a movement of the pole perpendicular to the longitudinal axis X of the fastening device 1 in the locked position. Exemplarily, the anti-slip inlay 15 comprises two corresponding teeth plates, wherein one of the two teeth plates is attached to each of the pole 2 and the frame 3. In the locked position, the two teeth plates 15 are engaged to one another.

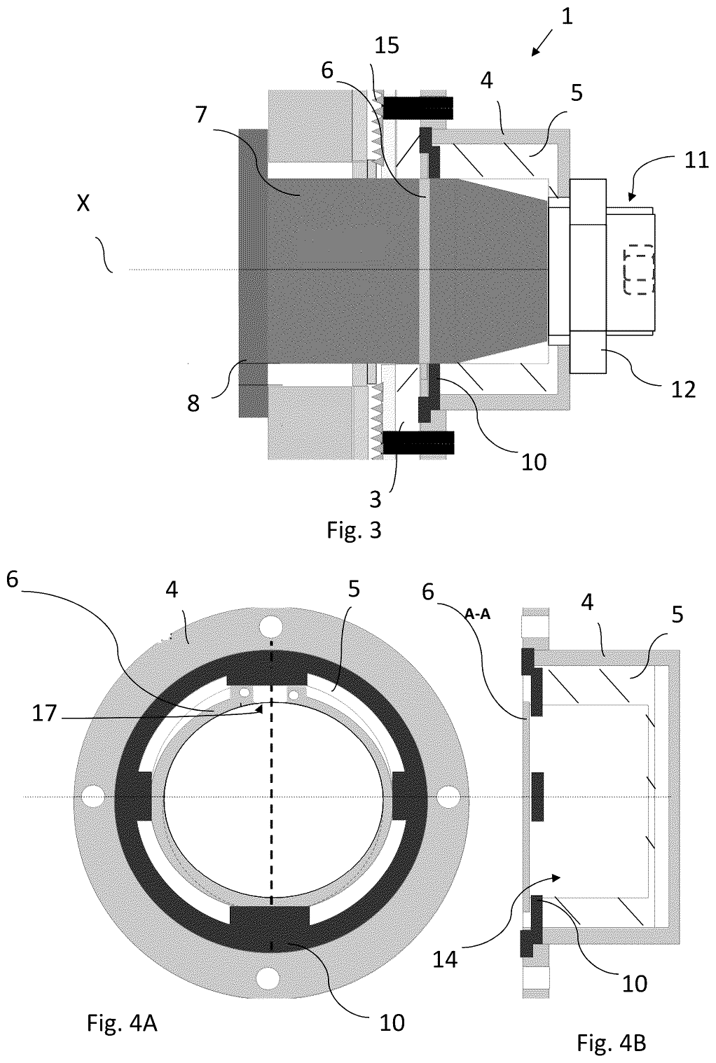

FIG. 3 shows a schematic illustration of a fastening system according to FIG. 2B with a threaded front area 11 of the locking bolt 7 and a nut 12 mounted on the threaded front area 11. The fastening device 1 in FIG. 3 distinguishes from the fastening device of FIG. 2B in that the enclosure 4 and the locator bush 5 each comprise a second opening. The threaded front area 11 reaches through the second openings. The nut 12 is mounted on the threaded front area 11 such that the fastening system is under pre-tension. Thereby, the nut 12 is supported by the enclosure 4, for example.

FIGS. 4A and 4B show a schematic illustration of an enclosure 4 housing a locator bush 5 according to an embodiment of the invention, wherein FIG. 4A shows the enclosure 4 in a front view and FIG. 4B shows the enclosure 4 in a sectional side view.

The enclosure comprises four through-holes for mounting the enclosure to the support structure 3. Exemplarily, the retaining element 6 is configured as an outer retaining ring. Furthermore, the positioning element 10 is configured as a ring, which is mounted to the enclosure 4, wherein the ring has protrusions extending from the ring towards the center of the ring 10. The protrusions of the positioning element/ring 10 are dimensioned such that the retaining ring 6 is blocked by the ring 10 in the longitudinal axis.

Further, the locator bush 5 has a nose 17 for example. In the unlocked position of the fastening device 1, the nose 17 spreads the two ends of the outer retaining ring 6 such that the retaining ring 6 is under pre-tension. As long as the fastening device 1 is in the unlocked position the retaining ring 6 is spread by the nose 17 of the locator bush 5 and the locking bolt 7 can slide through the open retaining ring 6 without mechanical resistance. When the locking bolt 7 pushes the slidable locator bush 5 in the locked position of the fastening device 1 the nose 17 removes from the two ends of the retaining ring 6, wherein the retaining ring 6 is kept in place by the positioning ring 10. Without the nose 17 not being placed between the two ends of the retaining ring 6 the retaining ring 6 closes due to the pre-tension.

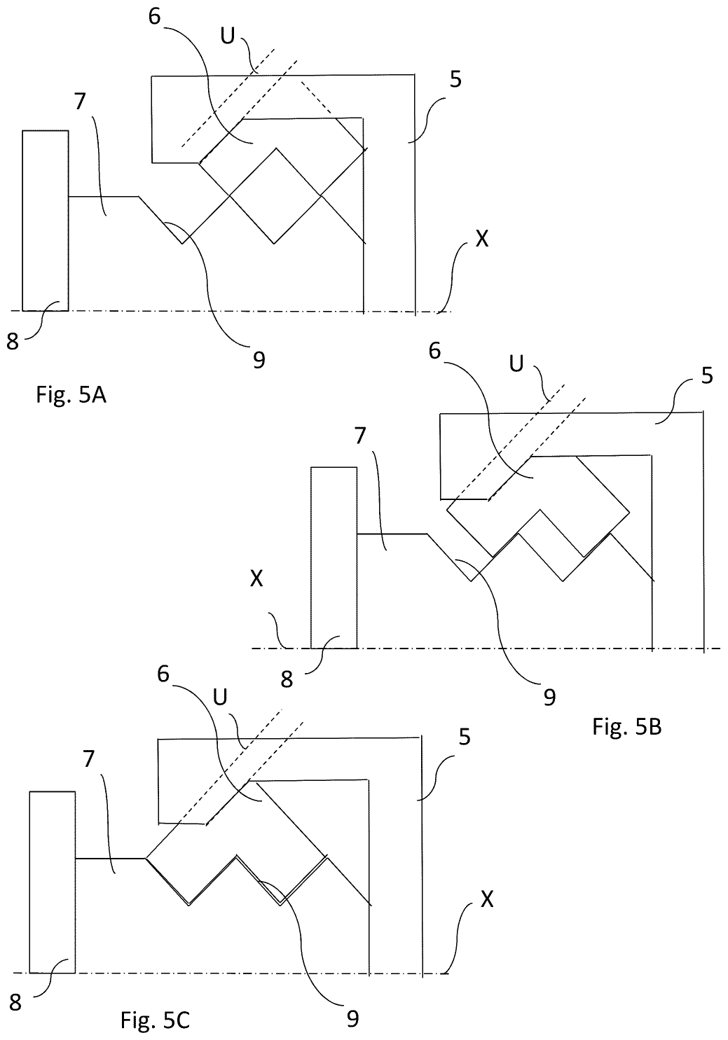

FIGS. 5A, 5B and 5C show a schematic illustration of a fastening device 1 with a retaining element 6 according to a further embodiment of the invention. FIG. 5A shows the fastening device 1 in an unlocked position, FIG. 5B shows the fastening device 1 in an intermediate position and FIG. 5C shows the fastening device 1 in a locked position.

The fastening device 1 according to the embodiment of FIGS. 5A, 5B and 5C substantially corresponds to the fastening device 1 according to the embodiment of FIGS. 1A and 1B, and distinguishes in that the retaining element 6 is configured as a sliding block.

The sliding block 6 slides guidedly towards the recess 9 of the locking bolt 7, when the locking bolt pushes the locator bush 5 in the longitudinal axis X in relation to the enclosure 4. FIG. 5B shows the fastening device 1 in an intermediate position, in which the sliding block 6 already engages with the recess 9 of the locking bolt 7. The recess 9 has a triangular cross-sectional shape. Furthermore, the locking bolt can have two recesses 9.

Further, the sliding block 6 is guided along a guiding axis U having an angle in a range of about 40° to about 50°, in particular having an angle of about 45°, in relation to the longitudinal axis X.

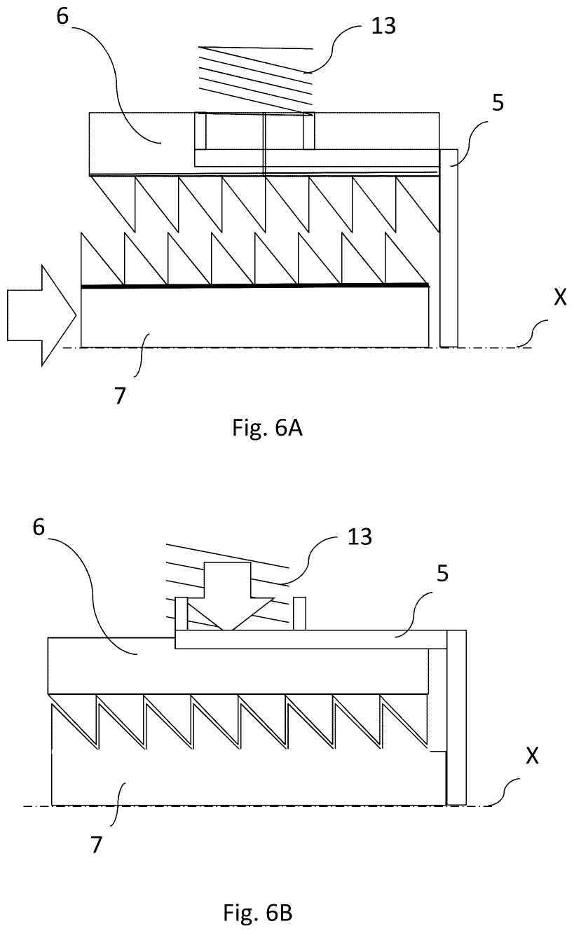

FIGS. 6A and 6B show a schematic illustration of a fastening device 1 with a retaining element 6 according to a further embodiment of the invention, wherein FIG. 6A shows the fastening device 1 in an unlocked position and FIG. 6B shows the fastening device 1 in a locked position.

The fastening device 1 according to the embodiment of FIG. 6A, 6B substantially corresponds to the fastening device 1 according to the embodiment of FIG. 1A, 1B and distinguishes in that the retaining element 6 comprises a pre-tensioned spring 13 for bringing the retaining element 6 into engagement with the recess 9 of the locking bolt 7, when the locator bush 5 is slid in the locked position of the fastening device 1 and thereby releases the spring 13.

Further, the retaining element 6 can comprise a plurality of teeth, which are directed to the locking bolt. Therefore, the recess 9 of the locking bolt 7 is shaped conveniently for being engageable with the plurality of teeth of the retaining element 6.

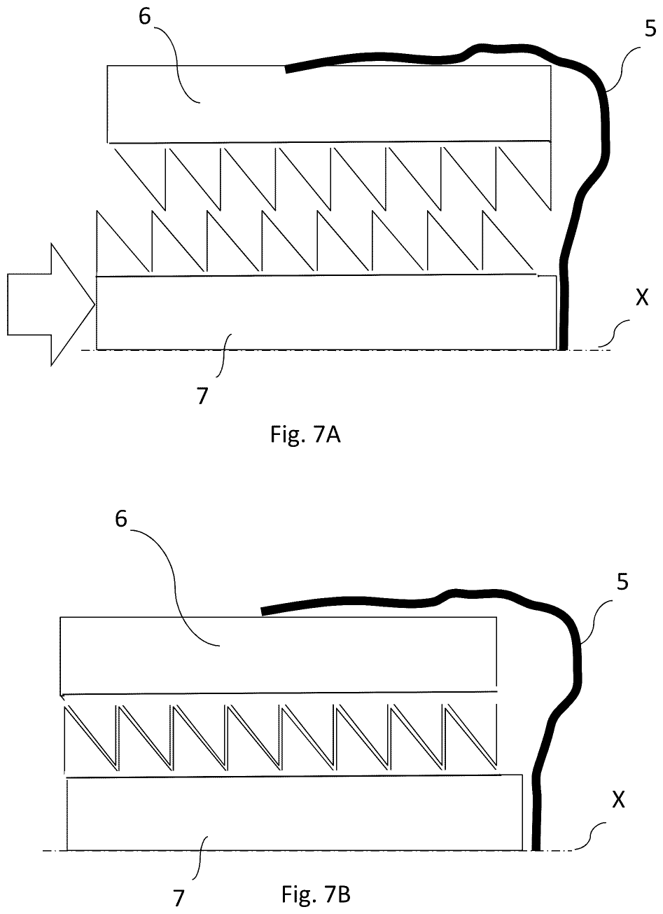

FIGS. 7A and 7B show a schematic illustration of a fastening device 1 with a locator bush 5 according to a further embodiment of the invention, wherein FIG. 7A shows the fastening device 1 in an unlocked position and FIG. 7B shows the fastening device 1 in a locked position.

The fastening device 1 according to the embodiment of FIG. 7A, 7B substantially corresponds to the fastening device 1 according to the embodiment of FIG. 1A, 1B and distinguishes in that the locator bush 5 is configured as a pivoting clamp.

The pivoting clamp 5 holds the retaining element 6 and reaches into the insertion area 14 of the enclosure 4 for inserting the locking bolt 7 such that the locking bolt 7 triggers the clamp to bring the retaining element 6 into engagement with the recess 9 of the locking bolt 7, when the locking bolt 7 is inserted into the enclosure 4 in the locked position of the fastening device 1. Thereby, the pivoting clamp can be plastically deformable and can be configured axisymmetric to the longitudinal axis X. Alternatively, the pivoting clamp can be hinged pivotable, wherein one end of the pivoting clamp 5 is mechanically coupled to the retaining element 6 and another end of the pivoting clamp 5 reaches into the insertion area 14 of the enclosure 4.

Further, the retaining element 6 can comprise a plurality of teeth, which are directed to the locking bolt. Therefore, the recess 9 of the locking bolt 7 is shaped conveniently for being engageable with the plurality of teeth of the retaining element 6.

In the detailed description above, various features have been combined in one or more examples in order to improve the rigorousness of the illustration. However, it should be clear in this case that the above description is of merely illustrative but in no way restrictive nature. It serves to cover all alternatives, modifications and equivalents of the various features and exemplary embodiments. Many other examples will be immediately and directly clear to a person skilled in the art on the basis of his knowledge in the art in consideration of the above description.

The exemplary embodiments have been chosen and described in order to be able to present the principles underlying the invention and their application possibilities in practice in the best possible way. As a result, those skilled in the art can optimally modify and utilize the invention and its various exemplary embodiments with regard to the intended purpose of use. In the claims and the description, the terms “including” and “having” are used as neutral linguistic concepts for the corresponding terms “comprising”. Furthermore, use of the terms “a”, “an” and “one” shall not in principle exclude the plurality of features and components described in this way.

The accompanying figures are intended to convey a further understanding of the embodiments of the invention. They illustrate embodiments and are used in conjunction with the description to explain principles and concepts of the invention. Other embodiments and many of the cited advantages emerge in light of the drawings. The elements of the drawings are not necessarily shown to scale in relation to one another. Direction-indicating terminology such as for example “at the top”, “at the bottom”, “on the left”, “on the right”, “above”, “below”, “horizontally”, “vertically”, “at the front”, “at the rear” and similar statements are merely used for explanatory purposes and do not serve to restrict the generality to specific configurations as shown in the figures.

In the figures of the drawing, elements, features and components that are the same, have the same function and have the same effect are each provided with the same reference signs—unless explained otherwise.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE LIST

1 fastening device
2 mechanical element, e.g., cabin fitting element
3 support structure, e.g., frame of fuselage
4 enclosure
5 locator bush
6 retaining element
7 locking bolt
8 bolt head
9 recess
10 positioning element
11 front area
12 nut
13 spring
14 insertion area
15 anti-slip inlay
16 rivet
17 nose
18 shank
X longitudinal axis
U guiding axis

The invention is:

1. A fastening device configured to fasten a mechanical element to a support structure, the fastening device comprises:
an enclosure mountable to the support structure;
a locator bush housed in the enclosure, wherein the locator bush is slidable along a longitudinal axis of the fastening device in relation to the enclosure in an unlocked position of the fastening device;
a retaining element positioned at least section-wise around the longitudinal axis, in the enclosure and mechanically coupled to the locator bush; and
a locking bolt including a bolt head configured to mount the mechanical element between the bolt head and the enclosure,
wherein the locking bolt is configured to be slidable into the locator bush, and
wherein the locking bolt includes a recess located on at least a section of a shell surface of the locking bolt and configured to be positively-locking connectable with the retaining element.

2. The fastening device according to claim 1, wherein the retaining element is fixed in relation to the enclosure along the longitudinal axis and movable perpendicular to the longitudinal axis.

3. The fastening device according to claim 1, wherein the locator bush is configured to bring the retaining element into engagement with the recess of the locking bolt in a locked position of the fastening device.

4. The fastening device according to claim 1, wherein the recess of the locking bolt is circumferential around the shell surface of the locking bolt and/or has a rectangular, a triangular or a curved cross-sectional shape.

5. The fastening device according to claim 1, further comprising a positioning element fixed to the enclosure and configured to block a movement of the retaining element along the longitudinal axis in relation to the enclosure.

6. The fastening device according to claim 1, wherein the locking bolt further comprises a thread in a front area of the locking bolt, wherein at least a section of the thread reaches through the locator bush and the enclosure in the locked position of the fastening device.

7. The fastening device according to claim 6, further comprising a nut mounted on the thread in the front area of the locking bolt such that the bolt head, the mechanical element, the support structure and the enclosure are pressed together in the locked position of the fastening device.

8. The fastening device according to claim 1, wherein the retaining element is configured as a retaining ring and is configured to be kept under pre-tension for installing the retaining ring on the locking bolt in the unlocked position of the fastening device by the locator bush, and which is engaged with the recess of the locking bolt in a locked position of the fastening device.

9. The fastening device according to claim 1, wherein the retaining element is configured as a sliding block, which slides guidedly towards the recess of the locking bolt, when the locking bolt pushes the locator bush in the longitudinal axis in relation to the enclosure.

10. The fastening device according to claim 1, wherein the retaining element comprises:
a pre-tensioned spring configured to bring the retaining element into engagement with the recess of the locking bolt, when the locator bush is slid in the locked position of the fastening device and thereby releases the spring.

11. The fastening device according to claim 1, wherein the locator bush is configured as a pivoting clamp which holds the retaining element and reaches into an insertion area of the enclosure for inserting the locking bolt such that the locking bolt triggers the clamp to bring the retaining element into engagement with the recess of the locking bolt, when the locking bolt is inserted into the enclosure in the locked position of the fastening device.

12. A fastening system comprising:
a support structure;
a fastening device according to claim 1, wherein the enclosure is mounted to the support structure; and
a mechanical element positively-locking connected with the fastening device.

13. The fastening system according to claim 12, wherein the support structure is configured as a frame of an aircraft, and wherein the mechanical element is configured as a cabin fitting element.

14. The fastening system according to claim 12, wherein the fastening device is in an opening of the frame.

15. The fastening system according to claim 12, further comprising an anti-slip inlay between the mechanical element and the support structure, wherein the anti-slip inlet is configured to reduce a movement of the mechanical element perpendicular to a longitudinal axis of the fastening device in a locked position of the fastening device.

16. A fastening system comprising:
a frame of a fuselage of an aircraft;
a cabin fitting element;
a fastening device including:
an enclosure mountable to a first opening in the fuselage;
a locator bush housed in the enclosure, wherein the locator bush has a longitudinal axis;
a locking bolt including a bolt head and a shank, wherein the shank extends through a second opening in the cabin fitting element, through the first opening and into the locator brush, wherein the cabin fitting element is between the bolt head and the frame along the longitudinal direction,
a recess in an outer surface of the shank, wherein the recess is oriented perpendicular to the longitudinal axis, and
a retaining ring oriented perpendicular to the longitudinal direction and positioned between the frame and the locator bush along the longitudinal direction or between the locator bush and the shank along a direction perpendicular to the longitudinal direction, wherein the retaining ring has:
a first configuration in which the retaining ring is seated in the recess and a second configuration in which the retaining ring has an inner ring edge with a diameter between a narrowest outer diameter of the shank and a widest outer diameter of the shank,
wherein as the locking bolt is inserted into the locator bush the shank displaces the retaining ring between the second configuration to the first configuration.

17. The fastening system of claim 16, wherein retaining ring is positioned between the frame and the locator bush along the longitudinal direction, and the shank as a tapered front region having the narrowest outer diameter of the shank and the recess is in a region of the shank with the widest outer diameter.

18. The fastening system according to claim 16, further comprising a positioning element fixed to the enclosure and positioned between retaining ring the and configured to block movement of the retaining element along the longitudinal axis relative to the enclosure.

19. The fastening system according to claim 16, wherein the locking bolt includes:
a threaded post fixed to a front of the shank, and the threaded post extends through an opening in a back wall of the enclosure, and
a nut attaches to the threaded post and the nut is adjacent an outside surface of the back wall of the enclosure.
